(19) United States
(12) Patent Application Publication
(10) Pub. No.: US 2016/0225289 A1
(43) Pub. Date: Aug. 4, 2016

(54) METHOD OF AND SYSTEM FOR TRAINING FOR CARDIAC EMERGENCY READINESS

(71) Applicants: John Ehinger, Wyndmoor, PA (US); Andrew Roeder, Berwyn, PA (US)

(72) Inventors: John Ehinger, Wyndmoor, PA (US); Andrew Roeder, Berwyn, PA (US)

(73) Assignee: CR2, LLC DBA CARDIOREADY, Conshohocken, PA (US)

(21) Appl. No.: 14/271,454

(22) Filed: May 7, 2014

(51) Int. Cl. G09B 23/28

(52) U.S. Cl. CPC G09B 23/288

(57) ABSTRACT

The present invention is provides a method and a system for training people to use Automatic External Defibrillators (“AEDs”). The method includes (1) the provision of at least one AED, (2) the assisting of the AED constituents in their compliance with applicable laws in the maintenance and training for use of the AEDs (at times inclusive of cardiopulmonary resuscitation (“CPR”) training) and in ensuring that life-safety standards are met, (3) the management of the information of people to be trained and those previously trained for use of the AEDs, (4) the enabling the training of trainees on the proper use of AEDs (and CPR techniques) and the confirmation of the knowledge of people trained previously, and (5) the supporting, as customized for each AED constituent, of on-going management of the various program aspects through a web-based interface. The system includes an AED, a database with applicable laws and standards, a database of user information, means of enabling the training, and a customizable web-based interface electronically connected to all of the foregoing elements.

### FIELD OF INVENTION

The present invention is directed towards a method of and a system for implementing a Cardiac Emergency Readiness (“CER”) training program that assists Automatic External Defibrillator (“AED”) trainees in learning, and trained individuals in confirming what they have learned regarding, the appropriate means and methods of helping victims of Sudden Cardiac Arrest (“SCA”). The program comprises the inventive combination of (1) supporting (maintaining) AEDs, (2) assisting in the compliance with the applicable laws with respect to maintenance of, training for, and use of such AEDs (at times inclusive of supporting cardiopulmonary resuscitation (“CPR”) training) and ensuring that life-safety standards are met, (3) managing the information of people selected to be trained and retrained, (4) training and confirming the knowledge of such people on the proper use of AEDs (and, as applicable, knowledge of CPR techniques), and (5) supporting the program, as customized for the applicable constituents, by providing on-going management of the various program aspects through a web-based interface. The system comprises the elements needed to perform the method.

### BACKGROUND O F THE INVENTION

Everyday thousands of people around the world die of Sudden Cardiac Arrest (“SCA”). SCA often strikes without warning, and after 4-6 minutes, irreversible damage or death can occur. Studies have shown that by the time paramedics or other medical personnel arrive, it is often too late, and without rapid assistance over 90% of SCA victims die.

In order to prevent some of these deaths, many organizations are now proactively addressing the issue of SCA by purchasing Automatic External Defibrillators (“AEDs”), which are devices that jolt the heart with electricity to help restore normal heart rhythm. In addition, an increasing number of organizations have begun to provide opportunities for individuals associated with the organizations to be trained in cardiopulmonary resuscitation (“CPR”). The primary intent of the purchases and increased training being to provide aid to those having cardiac problems.

Public access AEDs are designed to be used by non-medical personnel. These devices are simple to use, incorporating such user-friendly features as voice prompting during the operation of the device, and safety mechanisms that prevent the device from inappropriately delivering a shock. Various studies have confirmed the ability of young school-aged children to properly use AEDs with little to no training Besides the ease of use, the price of AEDs has dropped in recent years and has become affordable to a wide range of individuals and institutions. The technology has made it possible for lay people to safely and effectively administer assistance to cardiac arrest victims in almost any surrounding.

Notwithstanding this ease of use, however, it is imperative that the person using the AED be trained in order to maximize the ability to act quickly within the limited amount of time available to save the life of an SCA victim, as well as in compliance with various state and local regulations. There are many training programs available for people to learn to use, to be certified in the use of, and to be re-certified in the use of, AEDs. Many of such programs, however, are lacking in certain aspects. For example, many of the programs require “in-person” training Some that do not require such “in-person” training do not facilitate easy review of information learned or, maybe even more importantly, they do not support “re-teaching” of aspects of the AED use. This re-teaching is particularly important as multiple studies demonstrate that trainees' retention of subject matter learned can erode in as little as a few months. Other programs fall short on their ability to track (A) the instances when trainees signup for training, (B) the progress and effectiveness of the training, (C) the need for “re-teaching”, (D) the successful completion of training, and (E) any disassociations between trainees/trained people and the owner of the AED or its location (e.g., when a person leaves an organization). Further, many programs require the use of mannequins or mannequins-like props (and/or other specialized equipment), which adds a limiting aspect to the feasibility time, location, and affordability of the programs' administration.

### SUMMARY OF INVENTION

The present invention is directed to a method for training people to use AEDs, which includes (1) the provision of at least one AED, (2) the assisting of the AED constituents in their compliance with applicable laws in the maintenance and training for use of the AEDs (at times inclusive of CPR training) and in ensuring that life-safety standards are met, (3) the management of the information of people to be trained and those previously trained for use of the AEDs, (4) the enabling the training of trainees on the proper use of AEDs (and CPR techniques) and the confirmation of the knowledge of people trained previously, and (5) the supporting, as customized for each AED constituent, of on-going management of the various program aspects through a web-based interface.

In one embodiment of the present invention, the scheduling of training is managed based in part upon the use of a model that draws upon national, industry, and/or client unique data regarding turn-over, vacations, leave patterns, shift hours, and other relevant factors.

In the same or possibly another embodiment of the present invention, video-based training modules are used to present program instructions. These videos could be provided by various means including, for example, from a remote location via the Internet and/or made available through other electronic mean(s) of access, including wireless tools. Among other things, the video content trains proper use of AEDs, teaches emergency readiness and response protocols, and instructs on CPR techniques.

In still another embodiment of the present invention, which may include aspects of the foregoing embodiments, the training may be accomplished without the need for an “in person” instructor presence. In this case, trainees could have access to training content via, for example, computers. They could also, instead of traditional CPR mannequins and mannequin-like devices, use suggested surrogate/proxies, such as plastic bottles, athletic equipment and other readily available materials.

Other embodiments of the present invention may incorporate an assessment component whereby trainees/trained people would be required to remotely respond to a series of questions via the Internet and/or some other electronic interface(s). Those successfully completing the assessment could be deemed certified. A valid certification, documenting their successful completion of the training, might expire in a predetermined amount of time, for example, at the end of a 12 month period. At the end of such time or before, as established in accordance with the AED constituents' program parameters, “re-teaching” and/or “refresher” content could be made available to the trainee/trained people. If configured appropriately, the trainee/trained people could be alerted to the availability of the “re-teaching” and/or “refresher” content on a periodic basis or based upon some other timing parameter via email, Internet, and/or such other applicable electronic means.

In another embodiment of the present invention, which may include aspects of the foregoing embodiments, at completion of initial, re-teaching, or refresher training, trainees and others may be provided with additional reference materials in written or electronic form that can serve as supplemental learning tools to the content previously presented.

In one embodiment of the present invention, the program is managed through a system integrated with other systems and processes used to provide ongoing support for a customized emergency program, including computer programs used to provide on-going support for (maintenance of) the constituents' AEDs, maintaining compliance with applicable laws and ensuring that life-safety standards are met. Part of this integration might include automatic notices that will be provided to the AED constituents and users regarding assessment results as well as the currency, expiration, and renewal of training certifications.

Additionally, AED constituents, user and other designated persons/entities may have the ability to upload a listing of people to be trained and already trained into a database associated with the program via electronic means.

### BRIEF DESCRIPTION OF THE DRAWINGS

FIG. 1 is a flowchart showing the steps in a CER training method as contemplated by the present invention;

FIG. 2 is a flowchart showing details of certain aspects of a CER training method as contemplated by the present invention;

FIG. 3 is a flowchart showing an example of a single source, comprehensive cardio emergency program; and

FIG. 4 shows a system for CER training as contemplated by the present invention.

### DETAILED DESCRIPTION OF THE PREFERRED EMBODIMENTS

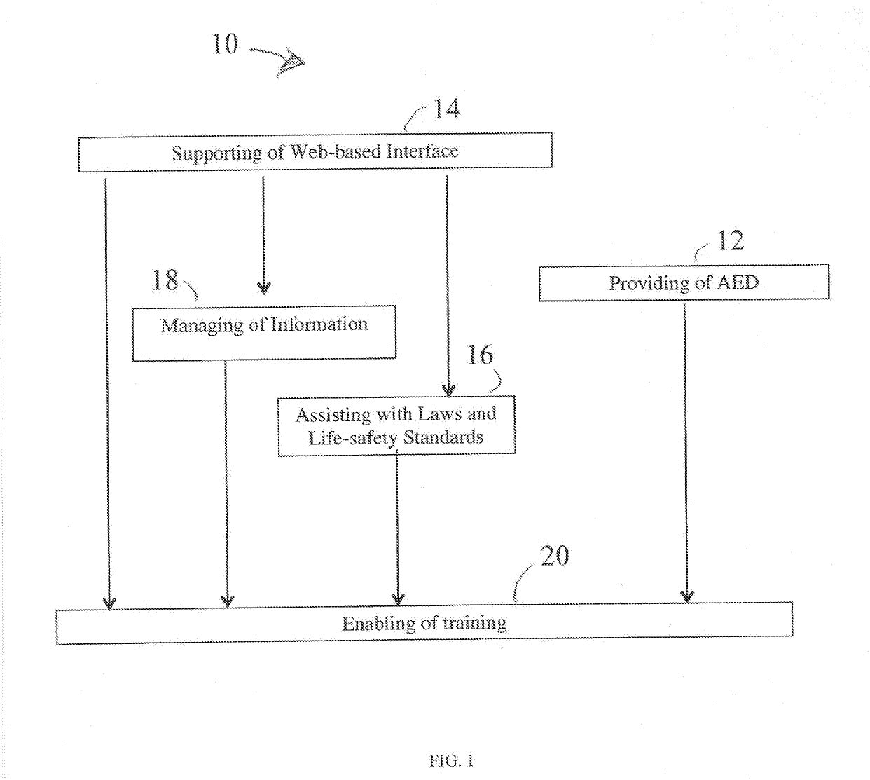

FIG. 1 shows a flowchart 10 that depicts the steps of the present invention. Essential to the embodiment of training program in this FIG. 1 is the provision of at least one AED to be used for the training (providing step 12). This embodiment of the present invention is facilitated through supporting step 14 through which a customizable web-based interface is electronically connected and operational with the assisting step 16 (assisting the people involved with such training in their compliance with applicable laws in the maintenance and training for use of such AED and ensuring that life-safety standards are met) and managing step 18 (through which the information of people to be trained and those previously trained for use of such AED is managed). The results of supporting step 14, managing step 18 and assisting step 16, along with the results of providing step 12, are the foundation for the enabling step 20. Enabling step 20 is ultimately the aspect of the present invention through which trainees are trained on the proper use of AEDs and the knowledge of people trained previously is confirmed.

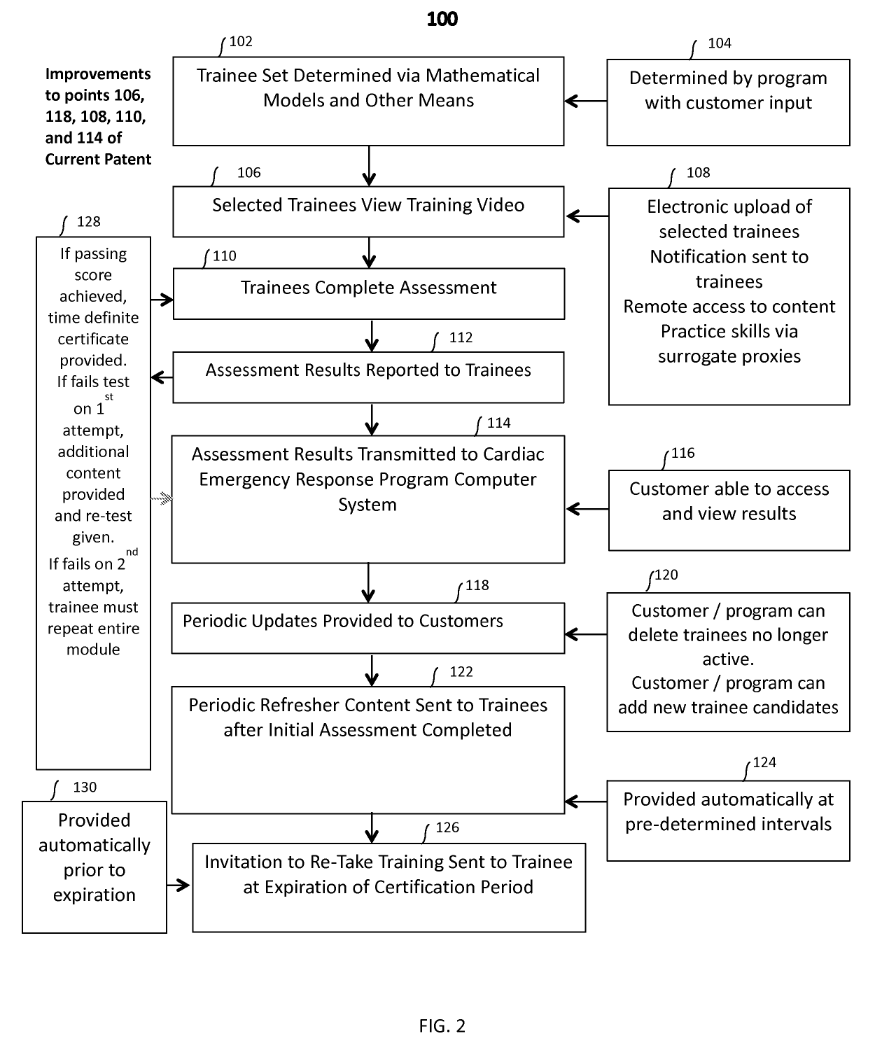

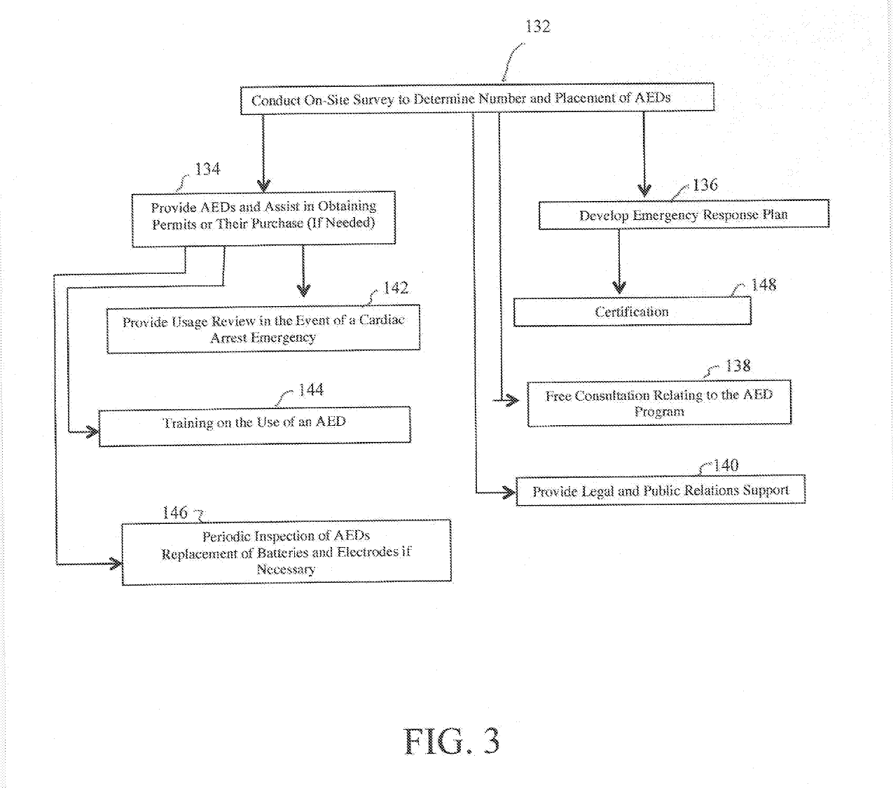

In the embodiment depicted in FIG. 2 (flowchart 100), the people to be trained are identified as one of the initial steps. Determination step 102 is accomplished through the use of mathematical models and other means. There are two main groups of people trained through the use of the inventive process—new trainees and people trained previously. Members of both groups can benefit from the teachings obtained through the inventive training process, be they new information for the people, ‘re-teaching’ of points not yet mastered or ‘refreshing’ of learning from the past. Where determination step 132 of FIG. 3 focuses on AEDs, determination step 102 focuses on people. The result of this determination step 102 is a list of candidates to be trained in the use of AEDs. One of ordinary skill in the art would note that the selection is also possible through other means and methods, including, for example, by a person volunteering or in accordance with some parameters (be they, for example, availability and interest) established by the person or people administering the training program. In this embodiment shown in FIG. 2, the input of the customer (for example, the person or entity that owns or otherwise responsible for the AED) 104 is also a step in the training process of flowchart 100.

This training process may be associated with the provision of a single source, comprehensive cardiac emergency program. FIG. 3 shows such a comprehensive program as shown in U.S. Pat. No. 6,694,299, whose teaching are herein incorporated by reference. As seen in FIG. 3, such a program may include step 144, for training people to use an AED 144. The steps of 102 and 104 in FIG. 2, parts of the inventive process, are examples of elaborations of the selection process leading to training 144 in FIG. 3.

FIGS. 1 and 2 each also show the steps involved in managing the information of people to be trained and those previously trained. For example, upload 108 is the step through which information regarding selected trainees are uploaded in a database for access as needed. One instance for such access is to assess the need for, and as appropriate to send, notifications to the trainees. Upload step 108 also represents the means by which content and videos illustrating practice skills are introduced into the inventive training process. It is the combination of the trainee determination process and the upload step that enables the trainees' ability to have access to desirable content, such as for example, videos. In this depicted embodiment, viewing step 106 is the training enabler through which the trainees can be taught about the use of AED and CPR techniques.

As mentioned previously, the inventive training process shown in FIG. 1 could be part of or otherwise integrated with the comprehensive program shown in FIG. 3. Thus, as with respect to the legal and public relations support 140 of the comprehensive program provided to its users, one skilled in the art would appreciate the same support taking the form of access to, for example, laws establishing compliance requirements for the maintenance and training for the use of AEDs and/or to life-safety standards.

A further elaboration of training step 144 of FIG. 3 with respect to the inventive training process, could take the form of, for example, assessment completion step 110, assessment reporting step 112, and assessment transmission step 114. These three steps are also, for example, parts of the training enabling step of FIG. 1. It is though such assessments that the trainee establishes and confirms that he or she has learned the material. It is also this set of assessment steps that result in the initiation of evaluation step 128 of the trainees' eligibility for receipt of a certificate. Evaluation step 128 (FIG. 2) is a precursor to certification step 148 (FIG. 3) in the program originally created, as shown in FIG. 2, in which the certification could be for individuals or organizations.

Continuing with the inventive training process, FIG. 2 shows the feedback steps of updates 118, content sending step 122, and invitation step 126. Further, updating step 118 is influenced by deletion/addition step 120, through which information regarding trainees is deleted from and added to the training process. These steps along with timing step 130 (prior to expiration) and timing step 124 (pre-determined intervals) enable the training process to be continuous and not static. All of the foregoing steps are manageable through a web-based interface (FIG. 1's supporting step 14), especially when the training process is customized through its web-based embodiment and the constituent of the AED can view resulting information (through, for example, the practice of viewing step 116). The inventive training process allows users to manage, on an ongoing basis, various aspects of the training process, including, without limitation, (A) the support and maintenance of AEDs, (B) the aforementioned assistance of people in such compliance with applicable laws and the ensuring that life-safety standards are met, (C) the managing of information of people to be trained and those previously trained, and (D) the enabling of training of trainees and the confirmation of knowledge of people trained previously.

One of ordinary skill in the art would recognize that the inventive training method could be used to also teach aspects of CPR training Further, the scheduling of training can be managed based in part upon the use of a model that draws upon national, industry, and/or unique data regarding turn-over, vacations, leave patterns, shift hours, and other relevant factors of potential trainees and people trained previously.

In a preferred embodiment of the inventive training process, training is accomplished through the performance of at least one video-based module. These video-based modules could be accessible by such trainees and people previously trained from at least one remote location through an electronic means of access. More preferably, such electronic means of access is through the Internet and similar means, including wireless tools, and such video-based module depicts proper use of such AED, teaches emergency readiness and response protocols, and instructs on CPR.

In still another embodiment of the present inventive training process, the training is performed through the use of computer-accessible content in lieu of ‘in-person’ instructors. In additional or alternatively, the training can be performed through the use of surrogate and proxy devices in lieu of traditional CPR mannequins and mannequin-like devices. Surrogate and proxy devices may include plastic bottles, athletic equipment and other readily available materials.

Still another, more specifically depicted embodiment, the present inventive training process includes the provision of a single source, comprehensive cardiac emergency program through which at least one AED is supported and maintained; the assistance to the people involved with such training in their compliance with applicable laws in the maintenance and training for use of such AED and the assurance that life-safety standards are met, the management of the information of people to be trained and those previously trained for use of such AED, the enabling of the training of trainees on the proper use of such AED and the confirmation of the knowledge of people trained previously, the assessment of the knowledge of trainees and people trained previously by reviewing responses to a series of questions for accuracy; and the support of customization of such training through a web-based interface through which authorized users with access to such web-based interface can manage, on an ongoing basis, various aspects of the training including such support and maintenance of such at least one AED, such assistance of people in such compliance with applicable laws and such assurance that life-safety standards are met, managing such information of such people to be trained and those previously trained, enabling such training of trainees and the confirmation of knowledge of people trained previously, and assessing the knowledge of trainees and people trained previously, wherein trainees and people trained previously remotely respond to such series of questions via an electronic means of access. Such electronic means of access may be via the Internet and similar means, including wireless tools. In this instance, trainees and people trained previously that fail to successfully achieve the predetermined level of accuracy established, the parameters of the assessment would have electronic access to those portions of the training content where the responses of such trainees and people trained previously were accurate.

Training may be accomplished in this aforementioned embodiment through the performance of at least one video-based module. Such assessment may be performed on a periodic basis. Further, the identity of people to be trained and people already trained may be included in a database accessible through such web-based interface and such trainee and people trained previously may be notified electronically of their schedules for training

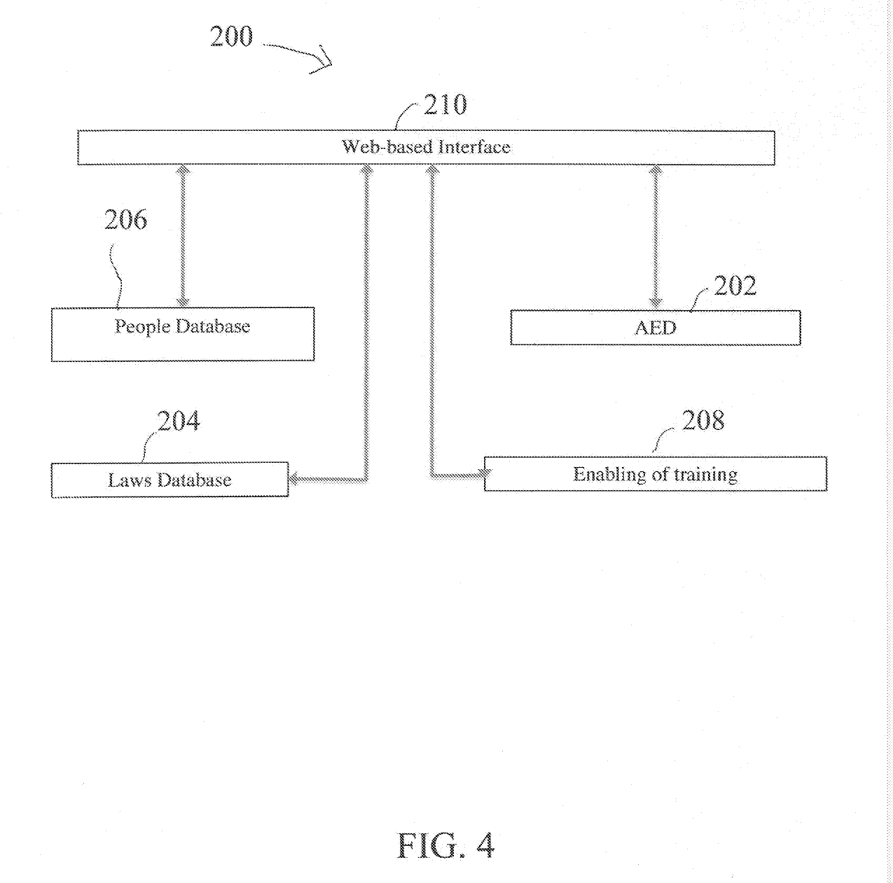

As shown in FIG. 4, the present invention for training people to use an AED also takes the form of a system 200. System 200, in a preferred embodiment, includes at least one AED 202. The AED preferably has embedded therein component and functionality that support the defibrillators electronic connectivity with other devices, system, subsystems and products. Through this connectivity, measurements that result from the use of the defibrillator may be recorded and conversely signals from such separate apparatus may be transmitted to such defibrillators. This interconnectivity supports, for example, the capability of system 200 to manage and record aspects of the training as trainees and others use the AED of the inventive system 200.

Another component of the inventive system 200 would be the laws database 204, in which information about the applicable laws of compliance to be followed in the maintenance and training for use of AEDs and life-safety standards would be stored. This database would be electronically connected to system 200 in manners and means known to one of ordinary skill in the art, which may be in the location with other components of system 200 or remote therefrom. Also electronically connected to and within system 200 would be a second database—people database 206—in which the information of people to be trained and those previously trained for use of such AED would be stored. Like the laws database 204, people database 206, may be local or remote from other components of system 200. In addition, people database 206 could be located with laws database 204.

Still another component of system 200 is the enabling means 208 of enabling the training of trainees on the proper use of such AED and the confirmation of the knowledge of people trained previously. Enabling means 208 could include, for example, a collection of instructional videos that are electronically accessible through the use of system 200. Such content and other enabling means may be located or stored at the location of the training or remotely.

Preferably, system 200 includes customizable web-based interface 210. Web-based interface 210 provides the means of accessing and controlling the other components and aspects of system 200. For example, a user could use web-based interface 210 through a computer to record and view readings from an AED electronically connected to web-based interface 210. Further, such user or another authorized user might use web-based interface through a mobile device connection to manage, on an ongoing basis, various aspects of the training process,. These users may access, for example, laws database 204 to verify the current rules and regulations that impact such training Other users, for example, users with administrative privileges, may use the same web-based interface 210, through a computer or mobile connection, to access people database 206 to, for example, view, update, revise, delete or otherwise manage information regarding such people to be trained and those previously trained. In the preferred embodiment, trainees and those previously trained (e.g., people intending to renew their certifications) could use web-based interface 210 to access enabling means 208 for such users to access training content and other materials.

In another embodiment of inventive system 200, system 200 is configured to be integrated with other systems and processes used to provide ongoing support for a customized emergency programs, including computer programs used to provide on-going support for, maintenance of, and compliancy of such at least one AED. System 200 can also incorporate means for automatically notifying the authorized users regarding assessment results as well as the currency, expiration, and renewal of training certifications.

The foregoing descriptions of the present invention have been provided for the purposes of illustration and description. It is not intended to be exhaustive or to limit the invention to the precise forms disclosed. Many modifications and variations will be apparent to the practitioner of ordinary skilled in the art. Particularly, it would be evident that while the examples described herein illustrate how the training process may look—end-to-end, certain elements/steps are essential to the present invention while others are supplemental. Further, other elements/steps may be used for and provide benefits to the present invention. The description of an embodiment of the present invention as shown herein is provided for purposes of illustration. It will be evident that the techniques described herein may be applied using other means.

The embodiments were chosen and described in order to best explain the principles of the invention and its practical application, thereby enabling others of ordinary skill in the art to understand the invention for various embodiments and with various modifications that are suited to the particular use contemplated.

1. The method of training people to use an automatic external defibrillator (“AED”) comprising the steps of:
(a) providing at least one AED ;
(b) assisting the people involved with such training in their compliance with applicable laws in the maintenance and training for use of such AED and ensuring that life-safety standards met;
(c) managing the information of people to be trained and those previously trained for use of such AED,
(d) enabling the training of trainees on the proper use of such AED and the confirmation of the knowledge of people trained previously, and
(e) supporting customization of such training through a web-based interface through which authorized users with access to such web-based interface can manage, on an ongoing basis, various aspects of the training including such assistance of people in such compliance with applicable laws, managing such information of such people to be trained and those previously trained, and enabling such training of trainees and the confirmation knowledge of people trained previously.

2. The method of claim 1 wherein such at least one AED is supported and maintained by way of a single source, comprehensive cardiac emergency program.

3. The method of claim 1 wherein the training is inclusive of cardiopulmonary resuscitation (“CPR”) training.

4. The method of claim 1 wherein the scheduling of training is managed based in part upon the use of a model that draws upon national, industry, and/or unique data regarding turn-over, vacations, leave patterns, shift hours, and other relevant factors of potential trainees and people trained previously.

5. The method of claim 1 wherein training is accomplished through the performance of at least one video-based module.

6. The method of claim 5 wherein such at least one video-based module is accessible by such trainees and people previously trained from at least one remote location through an electronic means of access.

7. The method of claim 6 wherein such electronic means of access is through the Internet and similar means, including wireless tools.

8. The method of claim 5 wherein such at least one video-based module depicts proper use of such AED, teaches emergency readiness and response protocols, and instructs on CPR.

9. The method of claim 1 wherein such training is performed through the use of computer-accessible content in lieu of ‘in-person’ instructors.

10. The method of claim 1 wherein such training is performed through the use of surrogate and proxy devices in lieu of traditional CPR mannequins and mannequin-like devices.

11. The method of claim 10 wherein such surrogate and proxy devices include plastic bottles, athletic equipment and other readily available materials.

12. The method of training people to use an AED comprising the steps of:
(a) providing a single source, comprehensive cardiac emergency program through which at least one AED is supported and maintained;
(b) assisting the people involved with such training in their compliance with applicable laws in the maintenance and training for use of such AED and ensuring that life-safety standards are met;
(c) managing the information of people to be trained and those previously trained for use of such AED,
(d) enabling the training of trainees on the proper use of such AED and the confirmation of the knowledge of people trained previously,
(e) assessing the knowledge of trainees and people trained previously by reviewing responses to a series of questions for accuracy via an electronic means of access; and
(f) supporting customization of such training through a web-based interface through which authorized users with access to such web-based interface can manage, on an ongoing basis, various aspects of the training including such support and maintenance of such at least one AED, such assistance of people in such compliance with applicable laws, managing such information of such people to be trained and those previously trained, enabling such training of trainees and the confirmation knowledge of people trained previously, and assessing the knowledge of trainees and people trained previously.

13. The method of claim 12 wherein such is electronic means of access via the Internet and similar means, including wireless tools.

14. The method of claim 12 wherein such trainees and people trained previously that failed to successfully achieve the predetermined level of accuracy established the parameters of the assessment would have electronic access to those portions of the training content where the responses of such trainees and people trained previously were accurate.

15. The method of claim 14 wherein training is accomplished through the performance of at least one video-based module.

16. The method of claim 12 wherein such assessment is performed on a periodic basis.

17. The method of claim 16 wherein
(a) the identity of people to be trained and people already trained is included in a database accessible through such web-based interface and
(b) such trainee and people trained previously are notified electronically of their schedules for training.

18. A system for training people to use an AED comprising:
(a) at least one AED;
(b) a database including information about the applicable laws of compliance to be followed in the maintenance and training for use of such AED and life-safety standards to be met;
(c) a database including the information of people to be trained and those previously trained for use of such AED,
(d) means of enabling the training of trainees on the proper use of such AED and the confirmation of the knowledge of people trained previously, and
(e) a customizable web-based interface
(i) electronically connected to record readings from such at least one AED and
(ii) through which authorized users with access to manage, on an ongoing basis, various aspects of the training through access to
(1) the database of such compliancy laws electronically connected to such web-based interface,
(2) the database information regarding such people to be trained and those previously trained electronically connected such web-based interface, and
(3) the means of enabling the training electronically connected such web-based interface.

19. The system in claim 18 wherein such system is integrated with other systems and processes used to provide ongoing support for a customized emergency programs, including computer programs used to provide on-going support for, maintenance of, and compliancy of such at least one AED.

20. The system of claim 18 further comprising means for automatically notifies the applicable system users regarding assessment results as well as the currency, expiration, and renewal of training certifications.
